(19) United States
(12) Patent Application Publication
(10) Pub. No.: US 2014/0310335 A1
(43) Pub. Date: Oct. 16, 2014

(54) PLATFORM FOR CREATING CONTEXT AWARE INTERACTIVE EXPERIENCES OVER A NETWORK

(71) Applicant: SNIBBE INTERACTIVE, INC., San Francisco, CA (US)

(72) Inventors: Scott Snibbe, San Francisco, CA (US); Alan Shimoide, San Francisco, CA (US)

(73) Assignee: SNIBBE INTERACTIVE, INC., San Francisco, CA (US)

(21) Appl. No.: 14/140,111

(22) Filed: Dec. 24, 2013

Related U.S. Application Data
(60) Provisional application No. 61/810,909, filed on Apr. 11, 2013.

(51) Int. Cl. H04L 29/06

(52) U.S. Cl. CPC H04L 67/42
USPC 709/203

(57) ABSTRACT

Various software services may benefit from enhancements to interactive services. For example, context aware interactive experiences over a network may benefit from a platform for their creation, distribution, and management. A method can include receiving an application descriptor at a user device from a server, wherein the application descriptor corresponds to an interactive application. The method can also include creating an application instance on an interactive experience processing system targeted to a platform's architecture and interactive capabilities based on the application descriptor. The method can further include responding to at least one action of a user of the interactive application via interactive multimedia rendered on the user device. The application instance can include an application core including at least one interaction node and at least one media node.

### CROSS REFERENCE TO RELATED APPLICATIONS

The present application is related to and claims the benefit and priority of U.S. Patent Application No. 61/810,909 filed Apr. 11, 2013, which is hereby incorporated herein by reference.

### BACKGROUND

1. Field

Various software services may benefit from enhancements to interactive services. For example, context aware interactive experiences over a network may benefit from a platform for their creation.

2. Description of the Related Art

There are conventional systems for real-time perception and response to an unencumbered user. Such unencumbered interactive experiences may utilize natural user interface techniques including gesture tracking, face tracking, voice recognition, touch, inertial sensing, and other forms of input that sense and respond to the natural unencumbered actions of human beings. These systems can include application programming interfaces (APIs), integrated development environments (IDEs), and platforms, such as coding toolkits, that can be used for creating unencumbered interactive experiences. These APIs, IDEs, and platforms may be helpful for building unencumbered interactive experiences, but they do not fully address issues of building experiences that can scale from a single interactive instance to a deployed network of multiple simultaneous instances in separate physical locations such as a retail chain stores, consumer “app store” markets, or healthcare networks.

These platforms do not address deployment, maintenance, retargeting to different device capabilities, organization, and data collection from interactive experiences in a network. In addition, they do not address issues specific to unencumbered interactive experiences when scaled to multiple locations.

### SUMMARY

According to certain embodiments of the present invention, a method can include receiving an application descriptor at a user device from a server, wherein the application descriptor corresponds to an interactive application. The method can also include creating an application instance on an interactive experience processing system targeted to a platform's architecture and interactive capabilities based on the application descriptor. The method can further include responding to at least one action of a user of the interactive application via interactive multimedia rendered on the user device. The application instance can include an application core including at least one interaction node and at least one media node.

In certain embodiments of the present invention, a method can include transmitting an application descriptor to a user device from a server. The application descriptor can correspond to an interactive application, The user device can be configured to create an application instance on an interactive experience processing system targeted to a platform's architecture and interactive capabilities based on the application descriptor. The method can also include providing an object-code executable version of a program targeted to the architecture and capabilities, either cached on servers, or at run-time.

A method, according to certain embodiments of the present invention, can include providing an application descriptor to be transmitted to a user device from a server, wherein the application descriptor corresponds to an interactive application, wherein the user device is configured to create an application instance on an interactive experience processing system targeted to a platform's architecture and interactive capabilities based on the application descriptor. The method can also include providing a content management system configured to customize the behavior and appearance of applications by modifying the application descriptor and associated media.

An apparatus, in certain embodiments of the present invention, can include at least one processor and at least one memory including computer program code. The at least one memory and the computer program code can be configured to, with the at least one processor, cause the apparatus at least to perform any of the preceding methods.

A non-transitory computer readable medium can be encoded with instructions that, when executed in hardware, perform a process. The process can include any of the preceding methods.

### BRIEF DESCRIPTION OF THE DRAWINGS

For proper understanding of the invention, reference should be made to the accompanying drawings, wherein:

FIG. 1 is a block diagram that represents an interactive experience according to certain embodiments of the present invention.

FIG. 2 is a block diagram that represents an interactive experience created with the platform according to certain embodiments of the present invention.

FIG. 3 is a block diagram of the app descriptor and its relation to the app instance according to certain embodiments of the present invention.

FIG. 4 is a block diagram that represents the networking of an app descriptor according to certain embodiments of the present invention.

FIG. 5 is a block diagram of the Interactive experience development platform.

FIG. 6 is a block diagram of a media and interaction node according to certain embodiments of the present invention.

FIG. 7 is a block diagram of the behavior component of a media and interaction node according to certain embodiments of the present invention.

FIG. 8 is a flow chart of an interaction element process according to certain embodiments of the present invention.

FIG. 9 is a block diagram of an interaction and node event system according to certain embodiments of the present invention.

FIG. 10 is a flow chart of the metrics generation process according to certain embodiments of the present invention.

FIG. 11 is a block diagram of a metrics system according to certain embodiments of the present invention.

FIG. 12 is a block diagram of a networked node system according to certain embodiments of the present invention.

FIG. 13 illustrates a method according to certain embodiments of the present invention.

FIG. 14 illustrates another method according to certain embodiments of the present invention.

FIG. 15 illustrates a further method according to certain embodiments of the present invention.

FIG. 16 illustrates a system according to certain embodiments of the present invention.

FIG. 17 illustrates another system according to certain embodiments of the present invention.

### DETAILED DESCRIPTION

As an unencumbered interactive experience is scaled to multiple instances, and multiple target device types with differing device capabilities, it may be helpful to preserve the interactive behavior of the experience as well as to maintain the relationship between the interactive experience and the perceived simulation from the interactive experience without significant effort in scaling and customization.

Building an unencumbered interactive experience that can be deployed in multiple locations on many different setups and hardware platforms may involve significant effort to maintain the perceived interactive experience across different sensors and different detection schemes, and may involve adjusting to variations of the user's perception of the simulation based on the orientation, scale, and technology of the display used.

An issue sometimes faced in deploying an unencumbered interactive experience in different physical locations is that the hardware and physical configuration may need to be altered to reflect the physical constraints of a specific location, economic constraints of a buyer, or other constraints or user preferences. Depending on the environmental conditions and restrictions, different physical locations may require different user detection setups with different camera or sensor technologies. The required display technologies and display size and orientation may also vary based on obstructions and available space and light requirements.

Further complications are that different sensors and platforms have widely varying capabilities and may discern the user differently. On the other hand, the user's interaction may need to be processed such that the perceived interactive experience is the same. Likewise, a user's perception of the user's interaction may also be affected by the display size, technology, and orientation to the user. To maintain a consistent experience on different hardware platforms, the interactive experience may need to take into account the context of the input and output devices as well as the physical configuration.

Scaling an interactive experience may involve effort to retarget the media, simulation, interaction, interaction design, any shared media, and metrics for a specific interactive instance with a different configuration and location. To maintain relevancy to a user, a scaled unencumbered interactive experience may need retargeted media, messaging, simulation, shared media, and metrics to reflect changes in geography, time or season, events or venues, sponsors, and the like. An example is a single unencumbered interactive experience that is deployed at multiple stadiums around the country. Though every instance has the same interactive behavior and provides the same interactive experience, each separate experience may have media or messaging specific to the venue or location while the shared media and metrics may reflect a user's interaction with customized content from each instance.

To address these challenges, certain embodiments of the present invention provide a system and method for developing scalable networked unencumbered interactive experiences that can easily be deployed and retargeted as separate instances on different hardware, locations, and configurations while maintaining consistent interactive behavior and a context relevant experience with relevant output, with minimal customization.

More particularly, certain embodiments provide a networked platform that can define and describe how a specific interactive experience responds to a user, via interactive multimedia, using specific media assets while preserving these behaviors and interactive experiences independently of the context and input or output devices. The platform can extract metrics, logs, and shareable media that are relevant to context, input, output, media, and behavior. This platform can define these interactive experiences in such a way that the description of any specific instance of these experiences and their associated behavior, media, context, logic, assets, logs, metrics, metadata, shared media, schedules can be stored as a file, a set of files, or in a database. The platform can collect context-specific metrics, context-aware user experience media for sharing, and logs. The data and files collected by the platform allow for targeted sharing, analytics, data mining, and maintenance of the networked interactive experiences. This networked platform can use the descriptions of these interactive experiences to allow distributed updates and purchases, customizations, retargeting, organization, and scheduling of each instance of the experience by modifying the definitions of the experience and by altering the associated media or altering the behavior parameters of the specific experience.

In short, certain embodiments provide a platform that can define and describe the interactive multimedia response of an unencumbered interactive experience, independent of the sensor devices or configuration context, to facilitate retargeting and deployment. Certain embodiments provide an interactive experience platform that can extract context relevant metrics, logs, and shared media from multiple networked instances of interactive experiences with minimal customization. Certain embodiments also provide an interactive experience platform that defines interactive experiences in such a way that the description of any specific instance of these experiences and their associated behavior, media, context, logic, assets, logs, metrics, metadata, shared media, schedules, and the like can be stored as a file, a set of files, or in a database such that these descriptions of interactive experiences can be used to distribute, maintain, customize, organize, and schedule interactive experiences in a network. Other features of certain embodiments can be seen in the following discussion.

An interactive system in certain embodiments can respond to the unencumbered interaction of a user. Such a system may be present in many different kinds of locations and environments, including home gaming systems. The system can include a sensor for detecting the user and the user's interaction (e.g. via computer vision or touch), a display, a processing system such as a computer, and the software that responds to the user via interactive multimedia, simulation, game logic, or other interactive system. The software can be written in a platform such as an application programming interface (API) or graphical user interface (GUI) based integrated development environment (IDE). Certain embodiments allow for the easy creation of interactive experiences that maintain a similar simulated behavior and rendering of this behavior in reaction to a user, independent of the devices or configuration context. Here, the configuration context can refer to the specific hardware, such as input and output interfaces and devices, with which the system is equipped.

Certain embodiments allow for automatic generation of metrics, logs, and shared media that are context relevant. Also, certain embodiments also define each interactive experience and what it does, what it uses, what it collects, and how it responds to the user in such a way that this description and definition can be easily distributed and generalized to multiple device types and configuration contexts.

In one embodiment of a platform, specific instances of the interactive experience can be written on a platform core that handles all of the shared functionality of an interactive experience such as networking, device interfaces, an asset system, media rendering, an event system, a metrics system, a scripting system, a parameter system, a physics simulation system, an interface system. The specific instance of an interactive experience can then built with this platform core and with experience specific code that describes the specific interaction experience and specific media usage. In one embodiment of the platform, the experience specific code can be written in a scripting language. In another embodiment of the platform, the experience specific code can be generated by a GUI interface. The platform core can be shared by all of the instances of interactive experiences and the platform core can be responsible for managing the interactive experiences that are on the processing system.

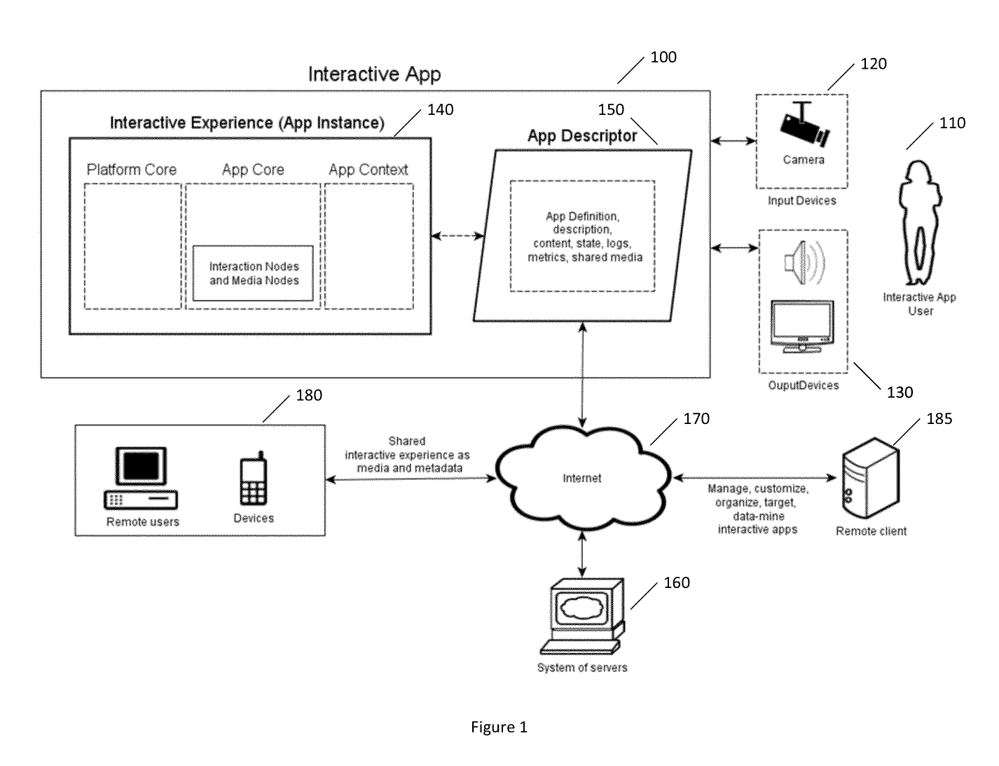

FIG. 1 is a block diagram that represents an interactive experience, described herein as an interactive application (app) 100, which can be created with the platform. An unencumbered interactive app user 110 can be detected by the interactive app 100 with input devices 120, such as a camera, and the interactive app 100 responds to the actions of the interactive app user 110 by a simulation rendered on the output devices 130. The interactive app 100 can be deployed, retargeted, data-mined, maintained, scheduled, organized, and shared to networked users using the Internet 170. The interactive app 100 can include the specific physical interactive experience, described herein as an app instance 140, and the app descriptor 150. The platform can define and describe every interactive experience developed with the platform as a unique app descriptor 150. The platform can also store the output and state of the interactive app instance 140 in the app descriptor 150. The app descriptor 150 can be an encapsulation of an interactive experience that can be transported and synchronized over a network. The app descriptor 150 can define and describe an interactive app, define and describe the files and data of the interactive app, represent the current state of the interactive app 100 and the context, and also contain data necessary for organizing and maintaining the interactive app. The app descriptor 150 can be a file, a set of files, or data in a database. The platform core can use the app descriptor 150 to create specific app instances on an interactive experience processing system. A networked system of servers 160 is used to distribute and synchronize updates to app descriptors using the Internet 170. The system of servers 160 can be cloud servers and can provide the app descriptors, updates, and the like as a cloud service. The system of servers 160 can then analyze and distribute subsets of app descriptors, such as shared media or metrics, to remote systems 180, 185 directly or via a web based interface.

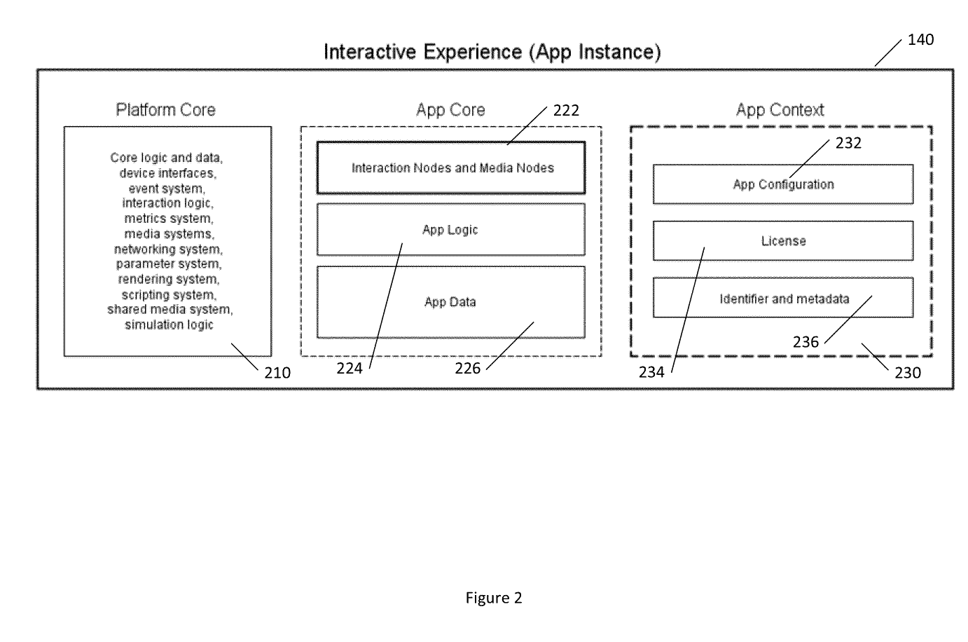

FIG. 2 is a block diagram that represents an interactive experience created with the platform. An app instance 140 can be a specific instance of an interactive experience that is running on a specific interactive processing system. The app instance 140 can include a platform core 210, which is shared by all interactive experiences created with the platform. The platform core 210 can be a set of shared libraries that are componentized so that each library can be configured independently of each other. The shared libraries include the logic and data of the core itself, device interfaces, an event system, a system of interaction logic implementations, a metrics system, media systems, a networking system, a parameter system, media rendering systems, a scripting system, a shared media system, and various simulation logic that are shared by multiple components.

An app instance 140 can also include an app core 220. The app core 220 can be what differentiates each interactive experience from each other interactive experience. A developer who creates an interactive experience on the platform may primarily develop the app core 220. The app core 220 can be the description, logic, and media of an interactive experience that is componentized into interaction and media nodes 222. Interaction and media nodes 222 describe the behavior and logic of an interaction in a device, and device capability agnostic fashion. The app logic 224 and app data 226 of the app core 220 can contain the data and logic for the experience that cannot be componentized into nodes such as a state machine for the simulation.

The context of an app instance 140 can be contained in the app context 230. The platform developer describes the app configuration 232 and metadata 236 while the platform generates the license 234 and identifiers. The app configuration 232 includes information about the devices, configuration, layout, network, and location of the app instance 140. The metadata 236 describes the interactive experience and also includes specific descriptions of the configuration. The identifiers of an app instance 140 are generated by the platform and are used to uniquely identify a specific app instance 140 and associated files on the system of servers 160. The app context 230 also includes the license 234. The license 234 is used to preserve the app instance 140 by preventing any unintentional changes to the app context 230 or app content. The license 234 includes machine identifying data, a cryptographic hash of the app files and app content, expiration dates for the license 234, geographic restrictions, schedule restrictions, usage restrictions, and compatible device restrictions.

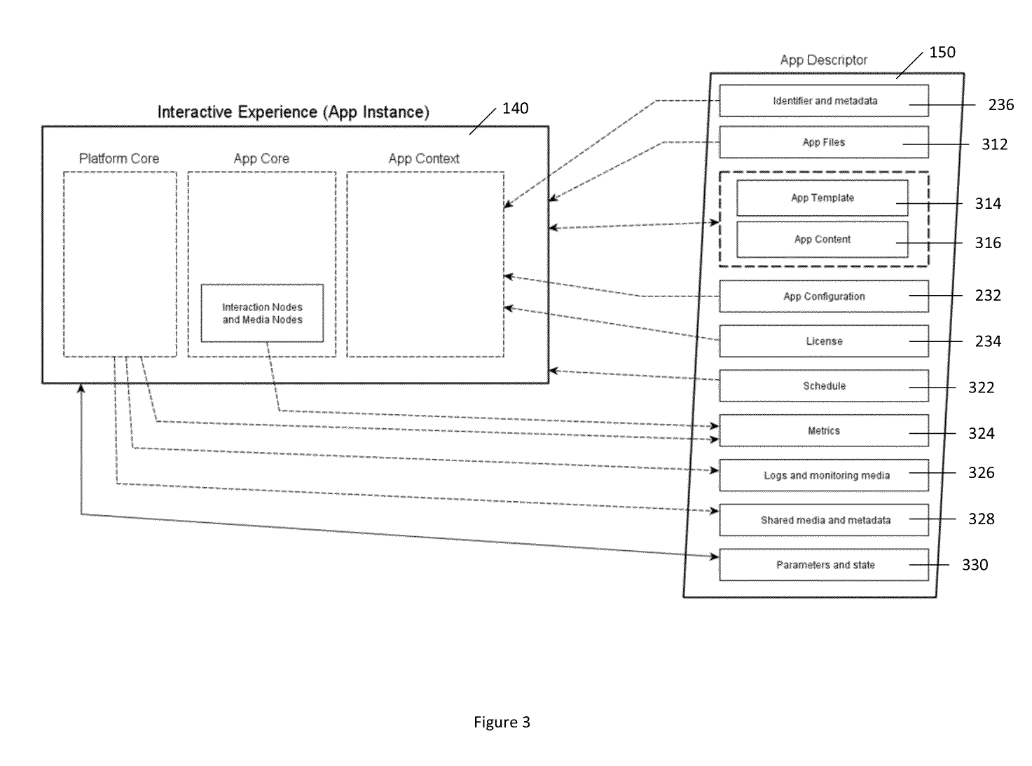

FIG. 3 is a block diagram of the app descriptor 150 and its relation with the app instance 140. The platform core 210 can generate a specific app instance 140 on an interactive experience processing system using the app descriptor 150. The platform core 210 can present an interface that allows a user to view the installed app instances on an interactive experience processing system and launch them using the descriptions and titles from the app identifier 236 of the app descriptor 150. The app identifier and metadata 236 can store the description and title, as well as identifiers to uniquely identify the app instance 140, in a database. The app identifier and metadata 236 can also be used by the system of servers 160 to create a web-based GUI 520 that allows clients to browse app instance 140 that they own as well as purchase or subscribe to new interactive experiences by reading the title and descriptions from the respective app identifiers in the app descriptors.

When deploying an app instance 140 on a new interactive processing system, the platform core 210 can use the app descriptor's app files 312, which can store key files used by the interactive experience and their storage locations, to set up a base application without media, data, scripts, and interaction content. The platform core 210 can build the rest of the app instance 140 from the app content 316 of the app descriptor 150. The app content 316 includes all of the files and data and the associated metadata 236 that are used by the app instance 140. The app content 316 can be organized into collections of files, data, and collections of collections and include the associated metadata 236 to describe the collections and their content. The metadata 236 stored in the app content 316 can include descriptions of content, storage locations of content, and versions information of content.

The platform can use the app template 314 to store a user-friendly description and hierarchy to content and data generated from interactions with the content. The platform can separate the system-level representation of the content, which is the app content 316, from the app template 314, which is the user-friendly description and organization of content. The app template 314 of an app descriptor 150 can represent an abstraction of the app content 316 and encompasses the usage, description, and organization of content as described by a developer or client. For example, the app template 314 could describe a collection of media as “insects.” The app template 314 could also describe a subset of “insects” as a “ladybug” and specify the parameters of the content that represent the instance of a “ladybug” as well as restrictions to the files or data that represent the “ladybug.”

The platform core 210 can use the app template 314 to generate metrics and shared media with context from a user's interaction with media. Using the app template 314, the platform core 210 can associate a user's interaction with media with the descriptions and hierarchy of the media contained in the app template 314. For example, the platform core 210 can create a metric that automatically describes the interaction of a user with a representation of a particular model and color of a toy by using the app template 314. The metric generated by the platform can capture the user interaction and the description and hierarchy of the content that the user is interested in without developer effort.

In one embodiment of the platform, the app template 314 can be used by the system of servers 160 to dynamically generate a web-based GUI 520 for modifying, organizing, and adding content. This web-based GUI 520 can be a content management system for managing the content of interactive experiences. The app template 314 can add descriptions, organization, usage, and restrictions to the app content 316 within the content management GUI. Changes to the app content 316 and app template 314 can then be synchronized by the system of servers 160 to interactive experience processing systems, through the app descriptor 150.

In one embodiment of the platform, the app template 314 can be used to generate descriptions of an app instance 140 for a web-based store where app instances can be purchased. The app template 314 can also be used by the system of servers 160 (see FIG. 1) to generate a targeted message for shared media and metadata 236 generated from the app instance 140. For example when a user shares the user's interactive experience, the user can automatically get a personalized message that thanks the user for the user's interest in the particular model and color toy with which the user was interacting at the particular venue.

The platform can use the app descriptor's app configuration 232 to add contextual information of a specific configuration of an app instance 140 to interactive experiences, the output from interactive experiences, and to the management of interactive experiences. The app configuration 232 can include, but is not limited to, information of the input devices, the output devices, the physical configuration, the output and input orientation, obstructions, the network configuration, geographic location, the layout of other interactive experience processing systems, hardware configuration, any arbitrary grouping or hierarchy of processing systems or interactive experiences, and hardware restrictions.

The platform core 210 can add such contextual information from the app descriptor's app configuration 232 to interaction components, media, metrics 324, and shared content 328. In addition, the app configuration 232 can be used by the system of servers 160 (see FIG. 1) to manage deployed app instances and interactive processing systems. In one embodiment of the platform, the app configuration 232 can be used by the system of servers 160 (see FIG. 1) to provide context for a user who remotely accesses an interactive experience processing system through a web-based GUI 520 hosted by the system of servers 160. The app configuration 232 can be used to find a particular interactive experience processing system by geography, layout, or grouping and hierarchy. For example a user can search for the interactive experiences associated with a grouping that the user created, called “store numbers.”

The platform core 210 can use the license 234 in the app descriptor 150 to regulate which app instances can be used on which interactive experience processing systems, as well as to prevent inadvertent modifications to the app instance 140, the app context 230, and app content 316 on the processing system. The system of servers 160 (see FIG. 1) can generate a new license 234 when new content is added or modified to an app descriptor 150 and the license 234 is synched by the app descriptor 150 to the processing systems. Content can be added or modified using an interactive experience content management system.

The platform core 210 can use a schedule 322 in the app descriptor 150 to schedule different app instances on a processing system as well as to schedule the content of an app instance 140. For example the platform core 210 can schedule a media asset such that it is only used on weekends while the app instance 140 is only active during the evening. In one embodiment of the platform, a client can use a web-based GUI 520, hosted by the system of servers 160, to modify the schedule 322 for app instances and for app content 316. The modification to the schedules are stored in the app descriptor 150 on the server and synced to interactive processing systems.

The platform core 210 can generate and store these items in the app descriptor: metrics 324, logs and monitoring media 326 such as screenshots, shared media and metadata 236, and parameters and state configuration 330. By storing state information along with parameters in the app descriptor 150, the system of servers 160 can modify these parameters and alter the state of an app instance 140 remotely. In one embodiment of the platform, a client can modify parameters and state configuration of an app instance 140 remotely using a web-based GUI 520 hosted by the system of servers 160. The state information stored in an app descriptor 150 allows a system of servers 160 to redeploy an app instance 140 and preserve the current state of the app instance 140 across different interactive experience processing systems. For example, if a processing system is replaced then the system of servers 160 can redeploy the interactive experiences associated with the original processing system and maintain the current state of those interactive experiences.

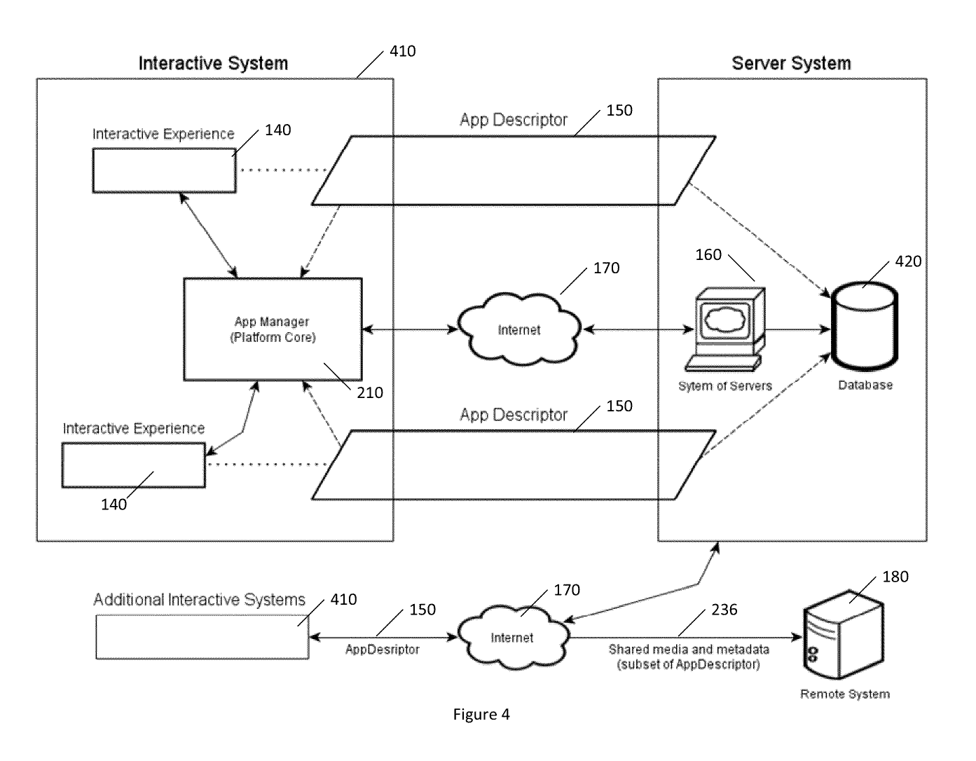

FIG. 4 is a block diagram that represents the networking of an app descriptor 150. The app manager, which is a component of the platform core 210, can be responsible for managing all of the interactive experiences on the interactive experience processing system 410. Each interactive experience can be described and defined by an app descriptor 150. The app manager can synchronize the app descriptors for each interactive experience with a server or system of servers 160 via the Internet 170. The server can store in a database 420 the synchronized version of every app descriptor 150 from all interactive experience processing systems. With the synchronized version of the app descriptor 150, the server can be used to recreate the current state of an interactive experience on any interactive experience processing system. The server can also distribute subsets of the app descriptor 150, such as shared media and metadata 236, to remote systems and use the app descriptor 150 to automatically add relevant messaging with the shared media. The server can send a targeted message to a user on a remote system with the shared media by using fields contained in the app descriptor 150 such as the description of the app in the app identifier, the location and venue from the app configuration 232, the media descriptor that accompanies the app content 316, and the popular usage of the experience from the metrics 324.

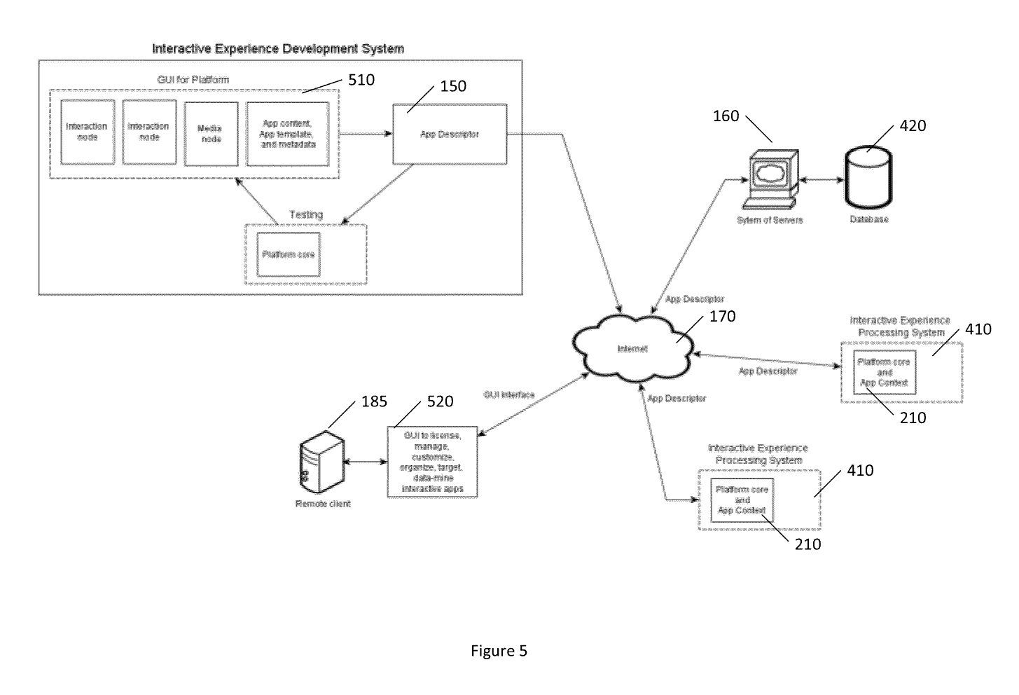

FIG. 5 is a block diagram of an interactive experience development platform. A developer can use the interactive experience development platform to develop interactive apps that are context aware, context relevant, networked and scalable. A platform GUI 510 can be used to develop interactive experiences. A developer writes scripts, code, and parameters that describe the interaction and media as interaction and media nodes 222. Interaction and media nodes 222 contain the definition, description, and logic for interaction and media components. Using the GUI 510, the developer can add files and data for the app content. The developer then creates an app template that describes and defines the app content usage. The developer can add titles, descriptions, and other descriptive fields to the metadata. The platform generates an app descriptor 150 that contains the nodes, content and context that was added by the developer.

The developer can then test the app instance 140, which can be generated by the platform using the app descriptor 150. The developer can choose to make more modifications after testing or send the app descriptor 150 to a system of servers 160 using the Internet 170. The system of servers 160 can use the app descriptor 150 to host a web-based GUI 520 for remote clients to license new experiences, manage, customize, organize, re-target, data-mine interactive experiences built with the platform. When a client licenses an interactive experience through the GUI 520, the system of servers 160 can deploy the app descriptor 150 to interactive experience processing systems 410.

Each interactive experience processing system 410 can include a platform core 210 and a basic app context 230 installed that describes the hardware and configuration of the interactive experience processing system 410. The platform core 210 on each interactive experience processing system 410 can synchronize previously installed app descriptors and new app descriptors with the system of servers 160. The platform core 210, on the interactive experience processing systems 410, can use the basic app context 230 to localize, re-target and configure a specific app instance 140 for the specific venue, location, and hardware without developer input.

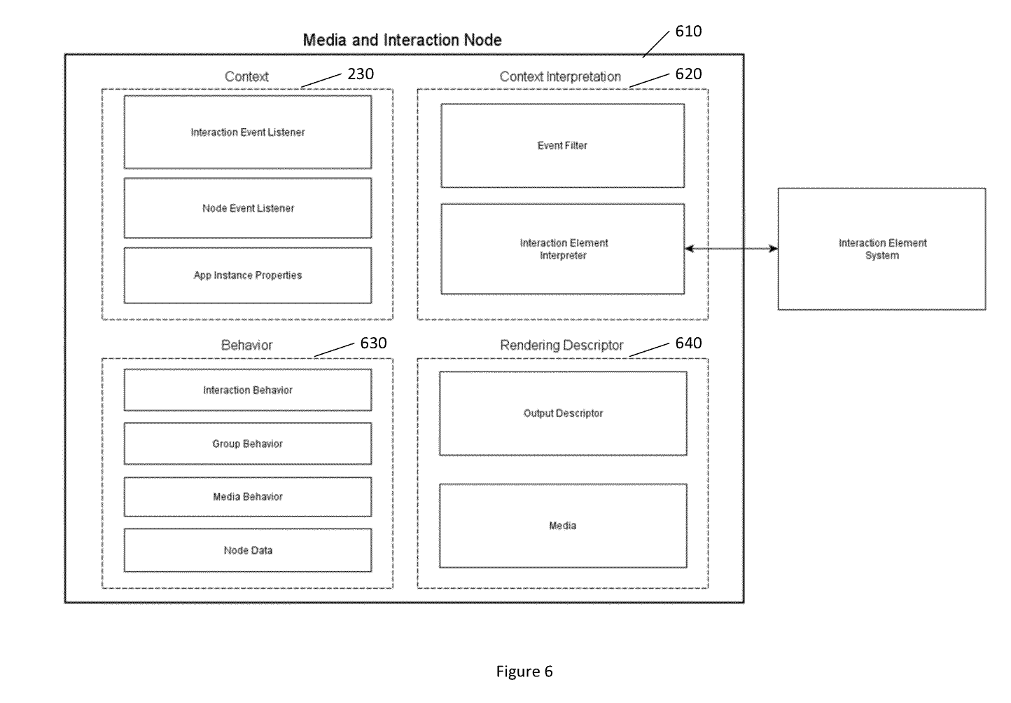

FIG. 6 is a block diagram of a media and interaction node 610. A developer of the platform can build interactive experiences by creating media and interaction nodes 610 that represent the behavior 630 and output of user interactive content while being agnostic of any context. A developer using the platform can create media and interactive nodes 610 by writing the behavior 630 and rendering descriptor 640 of a node. The platform can generate the context 230 and context interpretation 620 automatically from the described interactive behavior 630 and app context 230. The behavior 630 and rendering descriptor 640 can be abstractions of interactive media that are platform, hardware, and configuration independent. The platform can dynamically add the app context 230 to the node each time a node is instantiated on an interactive experience processing system 410. The platform can preserve the behavior 630 and output of an interaction for different configurations through this abstraction process.

The context 230 of a node can represent all of the factors outside a node that influence the behavior 630 and output of a node. User interaction and node-to-node interactions can be delivered to nodes as events. Events can be a callback system that sends data from input devices and node interactions in a standardized format. When a node is instantiated by the platform core 210, the platform core 210 can register the node for events that are relevant to the node based on the behavior 630 and the app context 230. Events can be combined with the app instance properties to provide context for the events that are received. The app instance properties can represent parameters of the specific instance and configuration of the app that are relevant for the node.

The context interpretation 620 of a node can use the context 230 of the system to provide a context relevant interpretation of the events to the behaviors 630. Event filters can apply context to events by translating data in events to node space coordinates, applying boundaries to event data, and applying any group restrictions to event data. Additionally, user interaction events can have additional context interpretation steps before being passed to the interaction behavior. Interaction behaviors can be described as sets of interaction elements. Interaction elements can describe a componentized simulated response to a user interaction, agnostic of the implementation or hardware used.

An interaction element interpreter can use the app context 230 to determine the best implementation of an interactive element that corresponds to a received interaction event. Implementations of interaction elements can belong to the interaction element system, which can be part of the platform core 210. The interaction element interpreter can pass context relevant implementation of interaction elements to the interaction behavior of a node. This dynamic translation from device specific interaction events to the appropriate device agnostic interaction behavior can be a component that facilitates context relevancy and retargeting in the platform.

To maintain a consistent user interactive experience across various configurations, or for other purposes, the platform can preserve the componentized behavior of nodes. The behavior 630 of a node can represent the response of a node to an input independent of the device and configuration. The interaction behavior can be the response and logic of a node in response to user interaction. The group behavior of a node can represent the actions and logic of a node in relation to a group. The group behavior can also represent the actions and logic of a group system contained in a single node. The media behavior can represent dynamic actions of media that are not direct responses of media to a user's interaction, such as, but not limited to, media on a path, animation easing of media, scaling of media, media sequences, spatially moving audio, and looping media. Node data 740 can be the data and parameters that a node stores to represent the node's state.

The rendering descriptor 640 of a node can describe the output of a node independent of the device or the configuration. The rendering descriptor 640 can contain the media of a node. The rendering descriptor 640 can also contain an output descriptor. The output descriptor can describe additional rendering effects that can be applied by the platform core 210 to the output. Examples of additional rendering effects are graphical effects such as iridescence, audio effects such as an echo, or video effects such as a blurred video effect.

An example of an interaction node is a box that a user pushes around. A developer using the platform can describe a box that has a behavior 630 that allows it to be pushed by a user. The interaction node of the box can listen for interaction events that represent a pushing interaction on the node. In one configuration, the interaction event can be created from a hand-tracking camera, while in another configuration the interaction events can be created from a touch-screen mobile phone or tablet display. The interaction element interpreter for the box can use the app instance 140 to determine the appropriate implementation of the interaction elements corresponding to the interaction events that will best preserve the interactive behavior 630 for the respective input. The interaction element interpreter can pass this implementation of the interaction elements representing a pushing action to the box. The interaction behavior can apply the appropriate interaction element implementation and behavior logic to the media that represents the box to simulate a box that has been pushed by a user. The media, coordinates, size, and output effects can be collected in the rendering descriptor 640 and sent to the platform core 210 for rendering.

A media and interaction node 610 may not describe a user interaction. An example of a media node without user interaction is an animated bird that flies across the screen when a door opens at regular intervals. The bird media node can listen for media node events from the door when it opens. The bird media behavior can describe the bird animation looping sequences, the bird animation path, the bird velocity, as well as what animation triggers the bird to fly. The output descriptor for the bird can contain any additional output parameters that are not contained in media itself. For example, the bird can have an iridescent effect described in the output descriptor that uses a previously implemented effect from the platform.

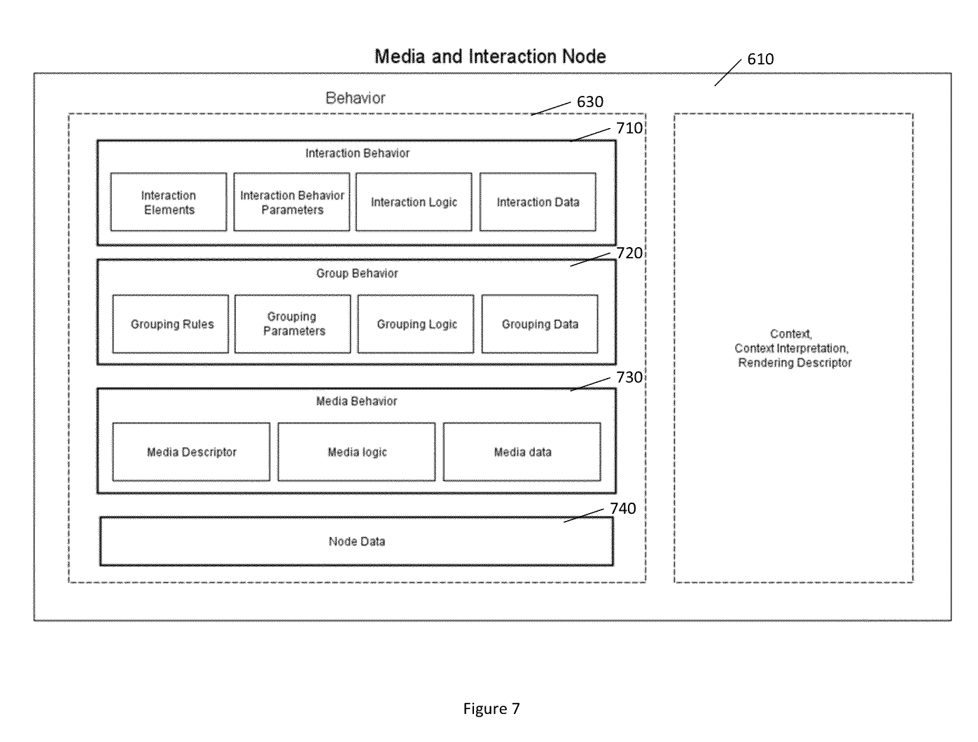

FIG. 7 is a block diagram of the behavior component 630 of a media and interaction node 610. An interaction and media node can be composed of interaction behavior 710, group behavior 720, and media behavior 730. The interaction behavior 710 can be described as a set of interaction elements. By describing interactions in an abstracted form it may be possible to retarget an interactive behavior onto different hardware or configurations while using the same interaction elements. An example of an interaction element is “follows” where an interaction node will follow different user representations based on the app context 230, but will have the same behavior. In this example, a node will follow a user identity when used with an identity tracking system, it will follow the central mass of a computer vision blob when used with a blob based system, it will follow the hands when used with a hand tracking system, and it will follow the feet when used on a floor. A blob in computer vision can refer to a region or points in an image that differ in their properties from a surrounding area.

Different interaction element implementations can be implemented within the platform and not in the node. A developer can use combinations of existing interaction elements to create new interaction behaviors 710 without creating new interaction elements. An interaction behavior 710 can be created by describing the behavior as sets of interaction elements in scripts and interaction behavior parameters. The interaction logic can use the interaction element implementations, from the platform core 210, to create the interaction behavior 710 in reaction to interaction and node events.

Group behavior 720 can be determined by grouping rules and parameters for the rules. Grouping rules can, for example, be created as scripts. Complex group behavior 720 can be composed of a set of simpler rules that an individual node applies to itself when in a group. Examples of grouping rules are a neighbor or target attraction rule, a neighbor or target avoidance rule, a collision avoidance rule, and a neighbor alignment rule. The grouping logic can be the logic for the behavior. The grouping logic can use the grouping rules to implement a reaction. Grouping logic can represent the logic for an individual component in reaction to its neighbors or the logic for entire systems of grouping behavior such as a system for simulating ants. In this example the ant system can be represented in a single interaction node. The individual ants can be parts of an ant system that is described in the group behavior 720. The ants can share all the interaction behavior 710, media, and grouping rules, since all ants are in the same node.

Media behavior 730 can be described in the media descriptor and by the media logic. Media descriptors can be specified for any media component attached to a node including audio and visual media. Media descriptors can include the title and description of media along with the behaviors of media that are not direct reactions to user interaction such as, but not limited to, animation, scaling, translation, rotation, audio effects, media looping, and other rendering and media post processing effects. Media descriptors can be created in the platform GUI 510 and can be include scripts in a scripting language. The media logic can use the media descriptor, media data, and media to implement the media behavior 730 of the node.

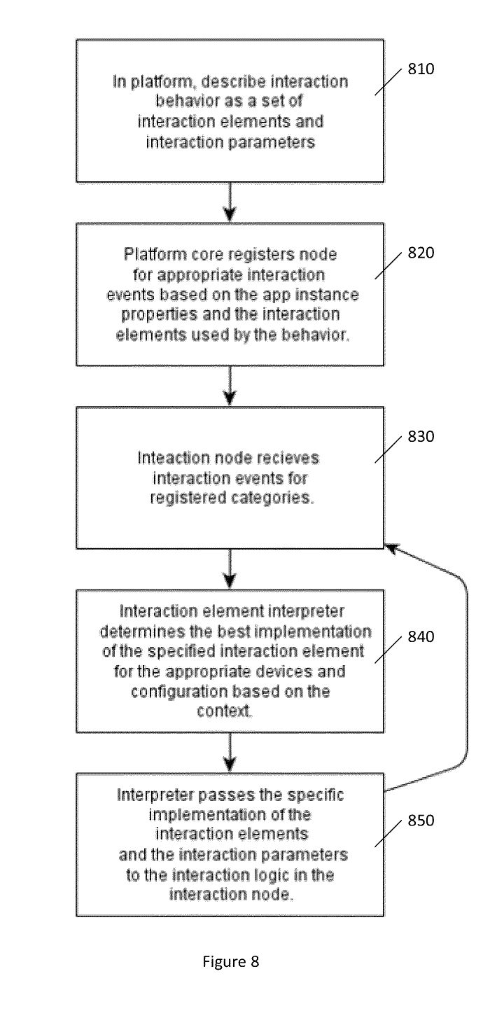

FIG. 8 is a flow chart of an interaction element process. The platform can, at 810, be used to describe each interaction and its expected behavior, relative to a user, as a set of interaction elements. Sets of interaction elements can compose the interaction behavior of a node. When the interaction node is instantiated in the app instance, the platform core can, at 820, dynamically register the interaction node to listen for the appropriate interaction events based on the interaction elements used to describe the interaction behavior and the app context. The interaction node can then, at 830, receive the appropriate interaction events based on the registered events. The events can then be passed to the interaction event interpreter that, at 840, can determine the best implementation of the interaction element based on the interaction behavior usage and the app context. The app context can include the hardware, orientation, configuration, and network of an app instance. The interaction element interpreter can then, at 850, pass the specific implementation of each interaction element that composes the behavior to the interaction logic in the interaction node.

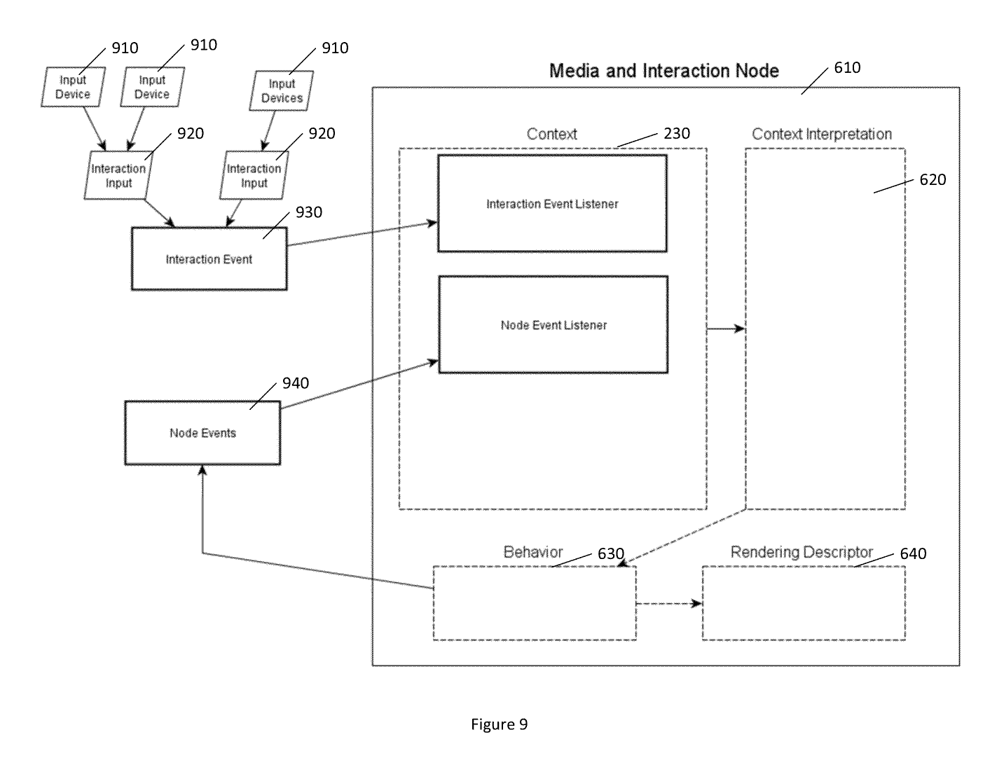

FIG. 9 is a block diagram of an interaction and node event system. Input devices 910 can first be processed into interaction inputs 920. Similar input devices 910 can produce the same interaction input. For example, one interaction input can be the depth image from a depth camera. All depth cameras can be processed into a depth image input. Different technologies can be used for creating and processing depth images including stereovision or structured light. Each technology may need to be processed differently and may require different post processing steps to create an optimal depth image. A final depth image is an example of an interaction input 920. Other interaction inputs 920 include but are not limited to color images, infrared images, velocity fields, thermal images, difference images, segmented images, segmented blobs, identity and position mapped inputs, blobs with localized velocity fields, blobs and images converted to vectors, point clouds, volumetric data, skeleton and joint mapped inputs, gesture inputs, faces, facial expressions, audio inputs, speech, magnetic field inputs, and radio frequency based inputs. Each class of interaction input 920 can triggers a unique interaction event 930. Media and input nodes can receive interaction events 930 from only relevant interaction inputs 920 based on app context 230 and the interaction elements representing the node behavior 630. Media and interaction nodes trigger node events 940 can be broadcast through the platform core 210 when a user interacts with a node or when a node interacts with another node. Nodes can receive node events 940 from nodes that are directly interacting with them and from other nodes that are within their node neighborhood, as determined by the platform core 210.

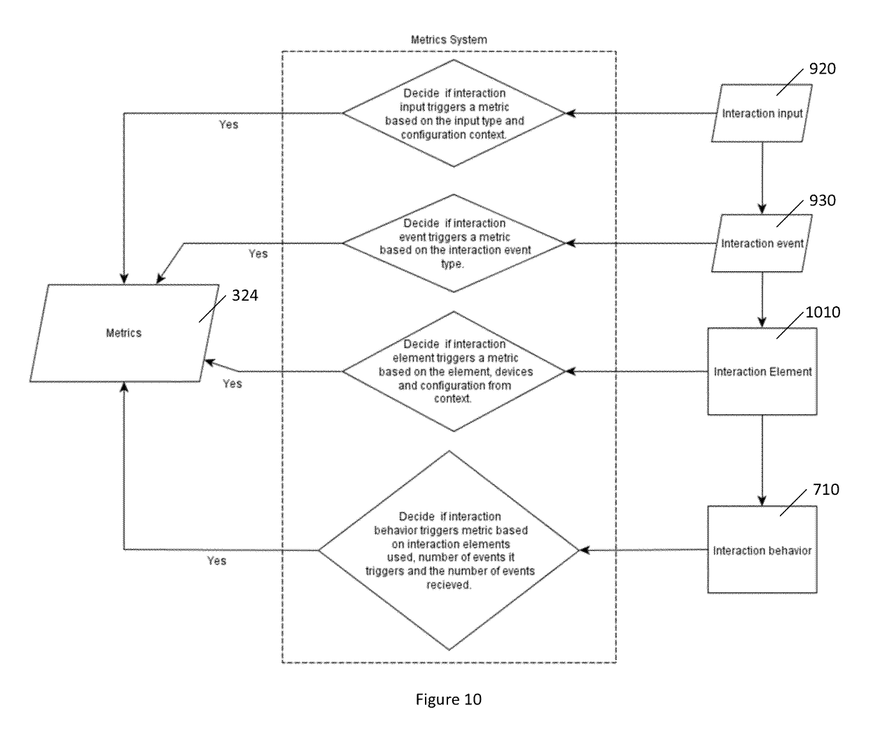

FIG. 10 is a flow chart of the metrics generation process. app instances created with the platform automatically generate context relevant metrics 324 from events, nodes, and interaction inputs. Nodes and interaction inputs are registered with a metrics system, which is a component of the platform core, when they are initialized.

The platform core automatically generates metrics 324 from interaction inputs based on the type of interaction input 920 and based on the app configuration. For example, a depth image as an input may not generate metrics 324 while a blob identity tracking interaction input may generate metrics 324 as new identities were added or removed over time if blob identities correlated to the traffic of users for a time period. However, a blob based identity tracking system's metrics 324 may not be collected if the tracked blobs did not represent users and instead represented hands due to the orientation of the device and the usage represented in the app configuration.

The platform core can automatically generate metrics 324 from interaction events 930 based on the type of interaction event though most interaction events 930 may not generate metrics 324 since the interaction behavior 710 may generate a more relevant metric. An example of an interaction event that may generate a metric is a blob based velocity field event that could measure the general activity level of blobs, when blobs correlate to users, or facial expression interaction events that produce metrics 324 based on different facial expressions regardless of whether or not a user is directly interacting with content or not.

The platform core can automatically generate metrics 324 from interaction elements based on the interaction element type and app configuration context. Interaction elements 1010 can represent a user's interaction without the relevant content so metrics 324 from interaction elements 1010 can provide usage patterns for a specific app context. For example interaction element metrics 324 can measure the overall engagement of users and their directed actions such as the length of time users spend pushing or pulling content in a branded experience compared to indirect or momentary user interactions such as users bouncing content.

The platform core can automatically generate metrics 324 from interaction behaviors 710 based on the interaction elements 1010 composing it, the number of events 930 this node is receiving, and the number of nodes this node is influencing through node events. Metrics 324 from node behaviors can app context relevant and can include the context of the content associated with the node behavior. The platform core can create a hierarchy of importance to distinguish interaction behaviors 710. The platform may only collect metrics 324 from the ranked interaction behaviors 710 based on preset parameters from the developer or as adjusted using a distributed parameter system. Interaction behaviors 710 that are deemed important and ranked higher than others may be the interaction behaviors 710 will trigger another node. Highly important nodes may be ones that trigger several nodes or receive a trigger from more than one node. The platform core can record these important and highly important node metrics 324 along with the accompanying metadata of the media content associated with the node and how a user interacted with the node, which is described by the interaction elements 1010. Examples of interaction behaviors 710 that may not generate metrics 324, other than overall usage metrics 324 from the interaction elements 1010, are simply pushing or pulling an interaction node without triggering any other interaction or media nodes, unless a developer overrides this. An example of an important interaction behavior that may trigger the collection of a metric 324 may be the user positioning a selector over a selectable option to select it.

This ranking of interaction behavior can be used to highlight logs, messaging, and to emphasize important interaction or animation events in shared media as well. For example, shared media can be automatically edited by the platform, to emphasize important and highly important interaction or animation events while cutting out un-eventful interaction.

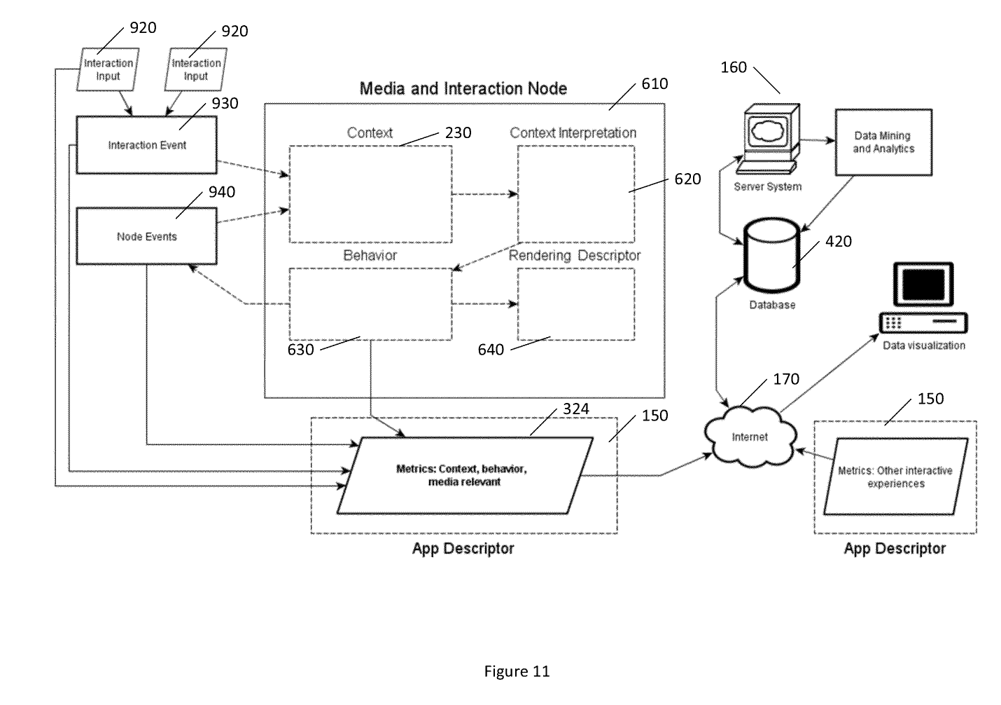

FIG. 11 is a block diagram of a metrics system. Context relevant metrics can be generated from interaction inputs 920, interaction events 930, node events 940, and node behaviors 630. The platform core 210 can store these metrics in the app descriptor 150 that can be synchronized to the system of servers 160 and stored in a database 420. The system of servers 160 can analyze the metrics 324 using the associated context of content, interaction, location, time, venue, and configuration to find patterns in the data. Such analysis can include data mining. A web-based GUI 520, hosted by the system of servers 160, is used to visualize the results of the data mining and analytics.

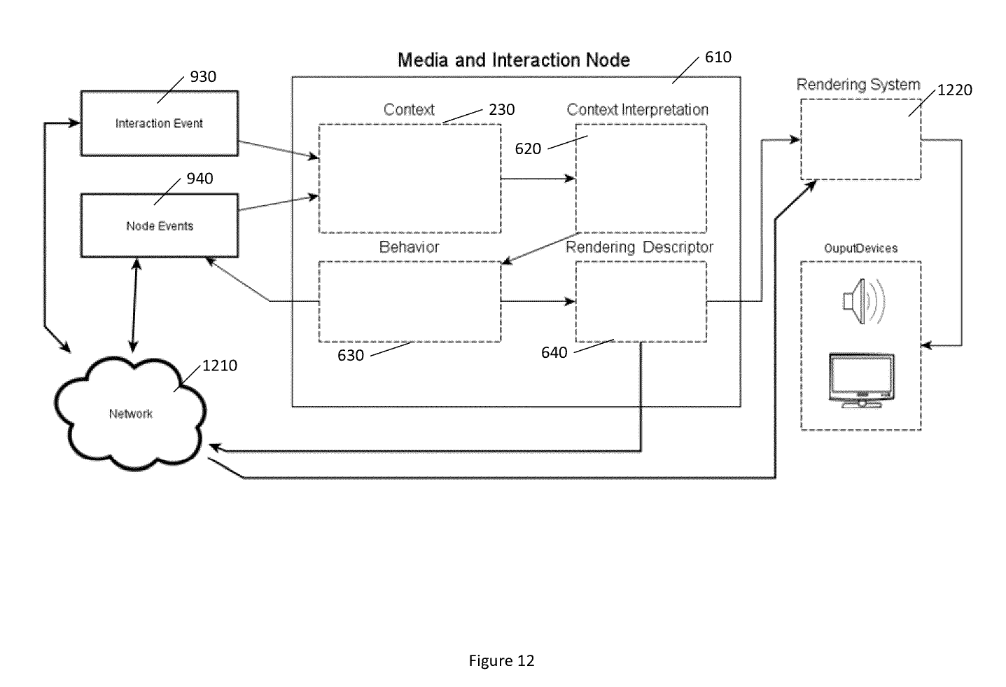

FIG. 12 is a block diagram of a networked node system. In one embodiment of the platform, the platform core can be connected to a network 1210 and can be networked with other platform cores either on the same interactive experience processing system or with other platform cores on other interactive experience processing systems. A media and interaction node 610 can receive and send node and interaction events on a network automatically through the platform core. The platform core can determine the events that a node receives from the app context 230 and node behaviors 630. The platform core can use the app context 230 to determine the layout of other networked processing systems and to determine the simulated world space. The platform core determines which events from the neighborhood of networked nodes are relevant using the node behaviors and app template.

Networked platform cores can send the simulation rendering information to a networked rendering system 1220, which can be on the same or different processing system than the nodes. Nodes can send the output of their rendering descriptors 640 to the networked platform core. The rendering system 1220 can output the visual and audio rendering information from the networked nodes as a simulation rendered on audio, visual, electromechanical devices.

Various embodiments are possible. For example, certain embodiments include a system for creating unencumbered interactive experiences that maintain consistent interactive user experiences using componentized interactive behaviors while preserving these interactive behaviors and simulated experience independently of the context and the input or output devices used. The platform can extract metrics, logs, and shareable media that are relevant to location, event, input devices, output devices, simulation device, installation context, media, user interaction, and simulated experience.

The system can include an interactive experience processing system, an output device, and a sensor for determining an unencumbered user's interaction with displayed media content. The system can also include a software platform for developing context and configuration agnostic interactive experiences. Moreover, the system can include a platform that dynamically translates user interaction from various interaction setups to the best implementation of the intended simulation behavior based on the specific configuration and user interaction.

The platform developer can describe the user interactive components as media, parameters, logic, and a set of device and configuration agnostic descriptions of the intended simulation responses to user interaction. The platform can use the developer-intended simulation responses and the configuration to automatically listen for the appropriate user interaction events and perform interpretation of various user interaction(s) to simulated behavior implementations to create a simulation response agnostically described.

The platform developer can, moreover, use a graphical user interface or a web-based interface to describe the user interactive components as media, parameters, logic, a set of device and configuration agnostic descriptions of the intended simulation responses to user interaction.

Also, in certain embodiments, the platform can automatically reflect any changes to devices, configuration, descriptions, organization, geography, time or season, event or venues, sponsors or affiliations, and content in the messaging that the platform uses in a simulation response to a user interaction and to messaging accompanying shared media from the user interaction experience.

In certain embodiments, the platform can automatically reflect any changes to devices, configuration, descriptions, organization, geography, time or season, event or venues, sponsors or affiliations, and content in the contextual metadata that the platform appends to metrics, logs, and shared media from the user interaction experience.

Furthermore, the platform can automatically collect and append contextual metadata to metrics from user interaction based on the device type, the user interaction type, the intended simulation response to the user interaction, and a hierarchy of interaction importance derived from the intended simulation response and the number of interaction or media components triggered by the intended simulation response.

The platform can automatically collect and append contextual metadata to shared media from user interaction. Moreover, the platform can dynamically edit shared media to highlight specific user interaction moments based on a hierarchy of interaction importance derived from the intended simulation response to the user and the number of interaction or media components triggered by the intended simulation response.

The interactive experience processing system can be networked with other interactive experience processing systems and the inputs detecting user interaction, as well as the outputs of componentized user interactions, the outputs of componentized media behaviors, the interaction between componentized media components, and the interaction between user interactive behavior components are transferred on a network.

In certain embodiments, the system can be networked with a system of servers and the interactive experience can be defined in such a way that the description of any specific instance of these experiences and their associated behavior, state, media, context, logic, assets, logs, metrics, metadata, shared media, and schedules can be synchronized on a network as a file, a set of files, or on a database.

Furthermore, in certain embodiments a system of servers can use the descriptions of the interactive experiences to distribute and synchronize these experiences for updates and purchases, customizations, retargeting, management of interactive processing systems, data-mining, and to schedule each instance of an interactive experience by modifying the definitions of the experience and by altering the associated media or altering the behavior parameters of the specific experience.

The system of servers can, in certain embodiments, use the descriptions of the interactive experiences to serve a web-based interface that allows a remotely located user to customize content, to customize parameters, to re-deploy a current instance of an interactive experience to another processing system, to license and purchase new interactive experiences, to apply updates to interactive experiences, to data-mine a single processing system or a network of processing systems, to schedule interactive experiences, to schedule content for interactive experiences, to monitor interactive experiences, to view logs or metrics for interactive experiences, to view shared media from interactive experiences, and to organize interactive experiences and processing systems in a hierarchy for networked interactive experience processing systems.

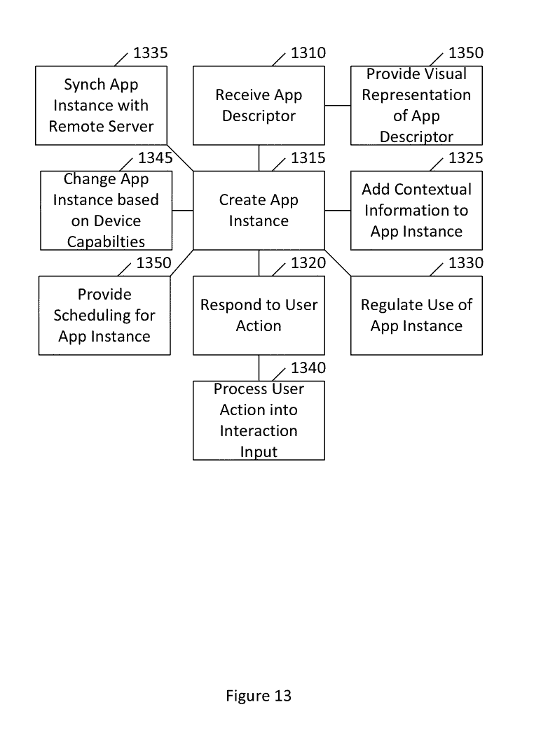

FIG. 13 illustrates a method according to certain embodiments. As shown in FIG. 13, a method can include, at 1310, receiving an application descriptor at a user device from a server, wherein the application descriptor corresponds to an interactive application. The method can further include, at 1315, creating an application instance on an interactive experience processing system targeted to a platform's architecture and interactive capabilities based on the application descriptor. The method can additionally include, at 1320, responding to at least one action of a user of the interactive application via interactive multimedia rendered on the user device. The interactive multimedia can include at least one of computer graphics, sound, video, audio, or interface elements. Other interactive multimedia are also permitted.

The application instance can include an application core that includes at least one interaction node and at least one media node. The at least one interaction node and the at least one media node can provide a description of at least one of behavior or rendering. The application core can further include application logic and application data.

The method can additionally include, at 1325, adding contextual information to the application instance based on an application configuration. The contextual information can include information regarding at least one of architecture, chips, memory, display characteristics, or interaction characteristics. Other contextual information is also permitted. The adding contextual information can include applying an event filter.

The method can also include, at 1330, regulating use of the application instance based on license information in the application descriptor. The method can further include, at 1335, synchronizing the application descriptor with at least one remote server.

The method can also include, at 1340, processing the at least one action of the user into an interaction input. The method can further include, at 1345, changing a type and quality of user interaction, interface, media, sequence, or media of the interactive application running on the user device based on device capabilities.

The method can additionally include, at 1350, providing a visual representation of the application descriptors and content management systems to end users.

The method can further include, at 1355, providing a scheduling application so that applications can be scheduled to run at specific times on an end-user device or network of end-user devices, with specific media elements or other specified time-targeted content. Examples of such scheduling may be for using a hospital to schedule physical therapy and entertainment.

The application instance of certain embodiments can be networked between users for remote interaction among users in, for example, multiplayer games, multi-person collaboration, multi-person learning, and the like.

The application descriptor can be configured to be encoded with one or more generic or specific interaction descriptions configured to be targeted to capabilities of user devices. The capabilities can include screen size, touch capability, mouse and keyboard capability, gesture sensing capability, voice recognition capability, and voice synthesis capability. For example, the application descriptor can be configured to target devices with small screens (such as mobile phones), devices with large screens (such as Internet-connected televisions), devices with touch capability (such as tablets and smartphones), devices with mouse and keyboard capability (such as laptop computers), devices with gesture sensing capability (such as devices equipped with 3D- or 2D cameras to sense user movement, as well as computer vision hardware, software, and algorithms), devices with voice recognition capabilities, and devices with voice synthesis capabilities.

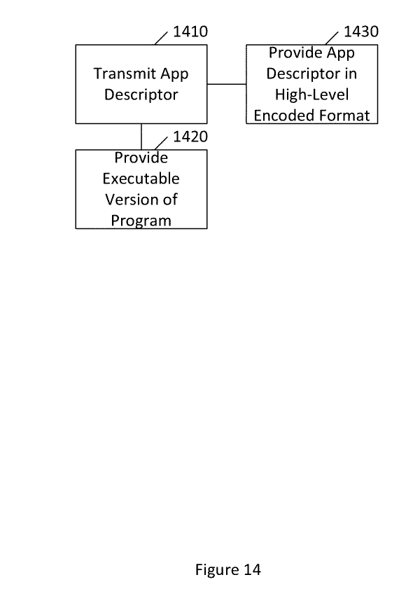

FIG. 14 illustrates another method according to certain embodiments. As shown in FIG. 14, a method can include, at 1410, transmitting an application descriptor to a user device from a server. The application descriptor can correspond to an interactive application. The user device can be configured to create an application instance on an interactive experience processing system targeted to a platform's architecture and interactive capabilities based on the application descriptor. The method can also include at 1420, providing an object-code executable version of a program targeted to the architecture and capabilities, either cached on servers, or at run-time.

The method can also include, at 1430, delivering the application descriptor in a high-level encoded format, which is interpreted by architecture-specific interpreters running on end-user devices. The high-level encoded format can be, for example, extensible markup language (XML), a scripting language, or another high-level descriptor.

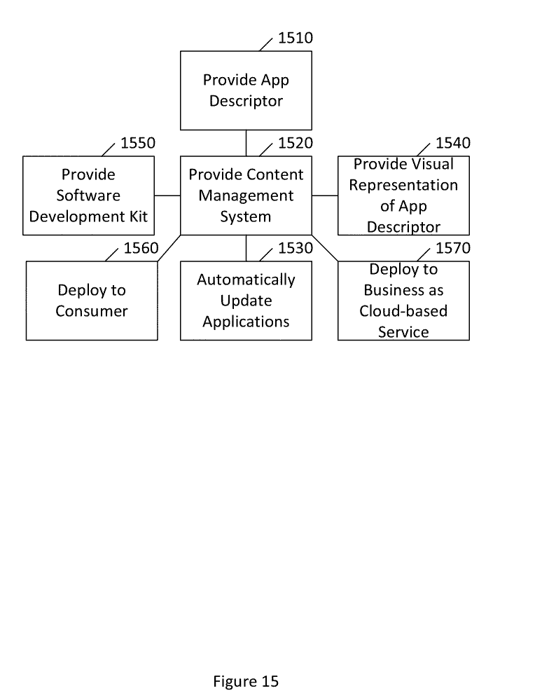

FIG. 15 illustrates a further method according to certain embodiments. The method can include, at 1510, providing an application descriptor to be transmitted to a user device from a server. The application descriptor can correspond to an interactive application. The user device can be configured to create an application instance on an interactive experience processing system targeted to a platform's architecture and interactive capabilities based on the application descriptor.

The method can also include, at 1520, providing a content management system configured to customize the behavior and appearance of applications by modifying the application descriptor and associated media. The method can further include, at 1530, automatically updating user applications when the application descriptor or media is updated on the server.

The method can additionally include, at 1540, providing a visual representation of the application descriptor and content management system to an application creator. The method can further include, at 1550, providing a software development kit to developers for creating application descriptors.

The method can also include, at 1560, deploying the application instance to a consumer for individual purchase or free download as a context-aware application or application feature. Moreover, the method can include, at 1570, deploying the application instance to a business as a cloud-based service for delivering a context-aware application or application feature to end users as a free or paid service.

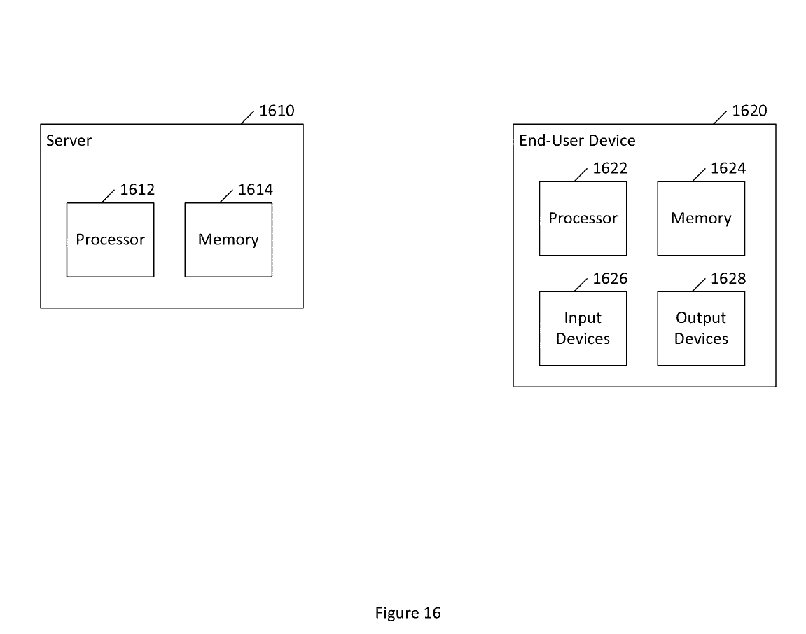

FIG. 16 illustrates a system according to certain embodiments. As shown in FIG. 16, the system can include at least one server 1610 and at least one end-user device 1620. The at least one server 1610 and the at least one end-user device 1620 can each include respective processors 1612, 1622 and memories 1614, 1624. Each processor 1612, 1622 can include one or more processing core and can be implemented a central processing unit (CPU), application specific integrated circuit (ASIC), or the like. Each memory 1614, 1624 can be any suitable storage device. The storage device may be, for example, a hard disk drive (HDD) or a solid state drive (SSD). Other forms of random access memory (RAM) are also permitted.

The end-user device 1620 can also include input devices 1626 and output devices 1628. The input devices 1626 can include devices such a touch screen, camera, keyboard, mouse, or the like. The output devices 1628 can include such things as a display or speakers. Other input devices 1626 and output devices 1628 are also permitted.

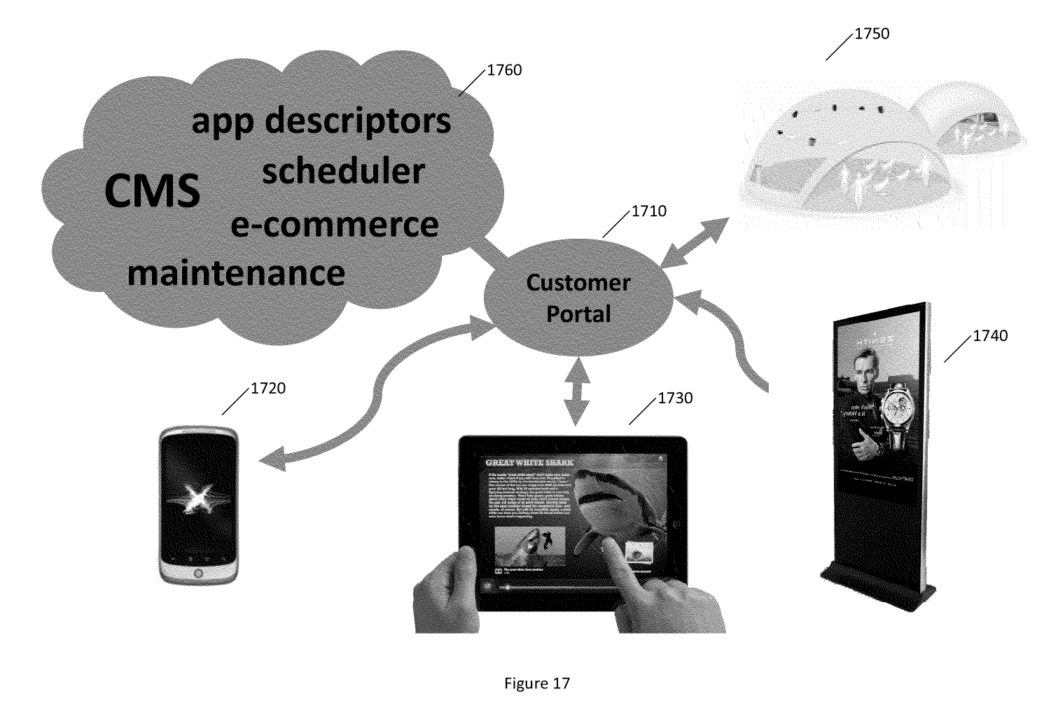

FIG. 17 illustrates another system according to certain embodiments of the present invention. As shown in FIG. 17, a customer portal 1710 can provide context aware interactive services to a variety of devices having a variety of contexts. For example, the customer portal 1710 can provide an interactive experience to a smartphone 1720, whose context may include a small touch screen, attitude sensors, such as gyroscopes, and cameras. Similarly, the customer portal 1710 can provide the same interactive experience to a tablet 1730, whose context may include a larger touch screen, attitude sensors, such as gyroscopes, and cameras. Moreover, the customer portal 1710 can provide the same interactive experience to a kiosk display 1740, which may have a touch screen, cameras, and gesture recognition. Additionally, the customer portal 1710 can provide the same interactive experience to a gaming room 1750, which may be equipped with cameras, gesture recognition, and eye tracking. The customer portal 1710 may be able to provide this experience by use of a cloud content management system (CMS) 1760 that includes application descriptors, a scheduler, e-commerce tools, and maintenance tools, among other things.

The application descriptor can be aware of, or taken into account, a context containing multiple devices. For example, certain embodiments can target apps into an environment with multiple simultaneous devices with different characteristics. Thus, if users have cell phones, tables, large displays, and small displays all in one room, an application descriptor can be aware of the context containing multiple devices, and have simultaneous, complementary behaviors on the different apps. For example, the application descriptor can permit picking photos on a phone, and having those photos displayed on big screens. In another example, the application descriptor can permit choosing weapons on a phone that get mapped to a 3D avatar of the person as he is tracked by a gesture system and appears on a large display.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

We claim:

1. A method, comprising:
receiving an application descriptor at a user device from a server, wherein the application descriptor corresponds to an interactive application;
creating an application instance on an interactive experience processing system targeted to a platform's architecture and interactive capabilities based on the application descriptor; and
responding to at least one action of a user of the interactive application via interactive multimedia rendered on the user device,
wherein the application instance comprises an application core comprising at least one interaction node and at least one media node.

2. The method of claim 1, wherein the interactive multimedia comprises at least one of computer graphics, sound, video, audio, or interface elements.

3. The method of claim 1, wherein the application core further comprises application logic and application data.

4. The method of claim 1, further comprising:
adding contextual information to the application instance based on an application configuration.

5. The method of claim 4, wherein the contextual information comprises information regarding at least one of architecture, chips, memory, display characteristics, or interaction characteristics.

6. The method of claim 4, wherein adding contextual information comprises applying an event filter.

7. The method of claim 1, further comprising:
regulating use of the application instance based on license information in the application descriptor.

8. The method of claim 1, further comprising:
synchronizing the application descriptor with at least one remote server.

9. The method of claim 1, wherein the at least one interaction node and the at least one media node provide a description of at least one of behavior or rendering.

10. The method of claim 1, further comprising:
processing the at least one action of the user into an interaction input.

11. The method of claim 10, further comprising:
changing a type and quality of user interaction, interface, media, sequence, or media of the interactive application running on the user device based on device capabilities.

12. The method of claim 1, further comprising:
providing a visual representation of the application descriptors and content management systems to end users

13. The method of claim 1, further comprising:
providing a scheduling application configured to run the application instance at a specific time on the user device or on a network of user devices, with specific media elements or time-targeted content.

14. The method of claim 1, wherein the application instance is configured to be networked between users for remote interaction among users.

15. The method of claim 1, wherein the application descriptor is configured to be encoded with one or more generic or specific interaction descriptions configured to be targeted to capabilities of user devices.

16. The method of claim 15, wherein the capabilities comprise screen size, touch capability, mouse and keyboard capability, gesture sensing capability, eye tracking capability, voice recognition capability, or voice synthesis capability.

17. The method of claim 1, wherein the application descriptor is configured to a context comprising multiple devices operating in coordination.

18. A method, comprising:
transmitting an application descriptor to a user device from a server, wherein the application descriptor corresponds to an interactive application, wherein the user device is configured to create an application instance on an interactive experience processing system targeted to a platform's architecture and interactive capabilities based on the application descriptor; and
providing an object-code executable version of a program targeted to the architecture and capabilities, either cached on servers, or at run-time.

19. The method of claim 18, further comprising:
delivering the application descriptor in a high-level encoded format, which is interpreted by architecture-specific interpreters running on end-user devices.

20. A method, comprising:
providing an application descriptor to be transmitted to a user device from a server, wherein the application descriptor corresponds to an interactive application, wherein the user device is configured to create an application instance on an interactive experience processing system targeted to a platform's architecture and interactive capabilities based on the application descriptor; and
providing a content management system configured to customize the behavior and appearance of applications by modifying the application descriptor and associated media.

21. The method of claim 20, further comprising:
automatically updating user applications when the application descriptor or media is updated on the server.

22. The method of claim 20, further comprising:
providing a visual representation of the application descriptor and content management system to an application creator.

23. The method of claim 20, further comprising:
providing a software development kit to developers for creating application descriptors.

24. The method of claim 20, further comprising:
deploying the application instance to a consumer for individual purchase or free download as a context-aware application or application feature.

25. The method of claim 20, further comprising:
deploying the application instance to a business as a cloud-based service for delivering a context-aware application or application feature to end users as a free or paid service.
